(19) United States
(12) Patent Application Publication
(10) Pub. No.: US 2009/0018788 A1
(43) Pub. Date: Jan. 15, 2009

(54) Normalization of process variables in a manufacturing process

(76) Inventors: Eric Nouali, Montpellier (FR); Maxim Zagrebnov, Montpellier (FR)

Correspondence Address: MURABITO HAO & BARNES LLP, Third Floor, Two North Market Street, San Jose, CA, 95113, US

(21) Appl. No.: 12/008,028

(22) Filed: Jan. 7, 2008

Related U.S. Application Data
(60) Provisional application No. 60/959,371, filed on Jul. 12, 2007.

(51) Int. Cl. G06F 19/00

(52) U.S. Cl. 702/84; 702/81

(57) ABSTRACT

A method of monitoring and controlling a manufacturing process is described. The value of a process variable is measured and treated. A measurement-based value is normalized using a normalization parameter associated with the process variable. Instances in which the normalized value fails to satisfy an acceptance criterion are identified so that, for example, corrective actions can be taken or the quality of the manufactured product can be diagnosed.

### RELATED APPLICATION

This application claims priority to the copending provisional patent application Ser. No. 60/959,371, Attorney Docket Number PDFS-0067US.PRO, entitled “Normalization: Creation of Robust and Generic Control Strategy,” with filing date Jul. 12, 2007, assigned to the assignee of the present application, and hereby incorporated by reference in its entirety. This application also claims priority to the French patent application entitled “Normalization of Process Variables in a Manufacturing Process,” Serial Number 0760414, filed on Dec. 28, 2007, which application is hereby incorporated by reference in its entirety.

### FIELD

Embodiments of the present invention generally relate to process monitoring and control in a manufacturing environment.

### BACKGROUND

To improve efficiency and reduce costs, fault detection and classification (FDC) software tools are used to control manufacturing equipment and processes used, for example, in semiconductor fabrication. FDC tools allow a manufacturer to accurately detect and identify process or tool problems that may arise, achieving faster product ramps and higher yields.

Once a control strategy has been defined, it is susceptible to perturbations such as adjustments to process settings, changes to hardware, and the effects of preventive maintenance. Preventive maintenance—such as cleaning or conditioning semiconductor process chambers, or changing parts—can impact process settings and other variables. Afterwards, several product runs may have to be completed before the control strategy can be adjusted (calibrated) to compensate for the effects of the perturbations. This may result in false alarms (when the manufacturing process is performing satisfactorily but the control strategy indicates otherwise) or reduced yields (when the control strategy is not yet able to detect or correct a problem within the manufacturing process).

Generally, a control strategy is built to monitor a single process recipe. Different process recipes may be used in each semiconductor process module at different times. There may be many process variables and each may have several different process setting values, depending on the purpose of a recipe. As a result, there are typically many different control strategies. A large number of control strategies can be difficult to manage and maintain.

### SUMMARY

Accordingly, there is a need to reduce the number of control strategies without sacrificing product quality or process control. Embodiments according to the present invention provide these and other advantages.

Embodiments of the present invention provide methods and systems for monitoring and controlling a manufacturing process. In one embodiment, the value of a process variable is collected (measured) and perhaps treated (analyzed or transformed). In general, the value of a process variable is referred to herein as a “measurement-based value”—a measurement-based value may be the actual measured (e.g., pre-treated) value of the process variable, or it may be the treated value. A treated value is also known as an “indicator.” In general, according to embodiments of the present invention, a measurement-based value of a process variable is normalized using a normalization parameter associated with the process variable. In one embodiment, it is the treated value that is normalized. Instances in which the normalized value fails to satisfy an acceptance criterion are identified so that, for example, corrective actions can be taken or the quality of the manufactured product can be diagnosed.

By normalizing the measurement-based values of process variables, control strategies are not dependent on the process recipes employed at various times within a module or stage (e.g., process chamber). Hence, the number of control strategies can be reduced, and consequently less time is needed to maintain and update them. Ideally, only a single control strategy is required for each stage. Also, the resulting control strategies are essentially insensitive to preventive maintenance, more robust, and can be readily deployed across modules and tools in the same family. Other advantages of normalization include reduced number of false alarms and tuned sensitivity.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a block diagram showing elements of a process monitoring system in accordance with one embodiment of the present invention.

FIG. 2 is a block diagram showing information flow in a process monitoring system in accordance with one embodiment of the present invention.

FIG. 3 is a flowchart of a computer-implemented method for monitoring a manufacturing process according to one embodiment of the present invention.

FIG. 4 is a flowchart of a method for controlling a manufacturing process according to one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or unless apparent from the context of the following discussions, it is appreciated that discussions utilizing terms such as “accessing” or “using” or “normalizing” or “identifying” or “calculating” or “dividing” or “receiving” or “comparing” or “applying” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions or components residing on some form of computer-usable medium, such as program modules, executed by one or more computers or other devices. Generally, program modules include routines, programs, objects, data structures, etc., that perform particular tasks or implement particular abstract data types. The functionality of the program modules may be combined or distributed as desired in various embodiments.

By way of example, and not limitation, computer-usable media may comprise computer storage media and communication media and combinations thereof. Computer storage media includes volatile and nonvolatile, removable and non-removable media implemented in any method or technology for storage of information such as computer-readable instructions, data structures, program modules or other data. Communication media can embody computer-readable instructions, data structures, program modules or other data in a modulated data signal such as a carrier wave or other transport mechanism and includes any information delivery media.

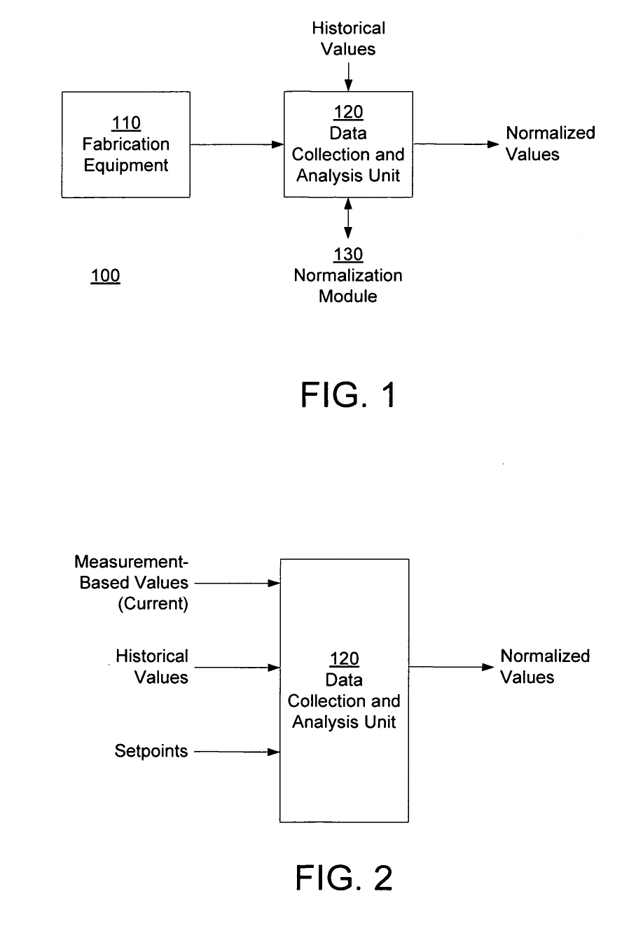

FIG. 1 shows elements of a process monitoring system 100 in accordance with one embodiment of the present invention. In general, system 100 includes fabrication equipment 110 and data collection and analysis unit 120. In one embodiment, the fabrication equipment 110 includes process chambers, reactors, steppers, etchers, and other tools and instruments associated with the fabrication of manufactured products. In one embodiment, the manufactured products are semiconductor devices such as, but not limited to, wafers. The type of equipment used depends on the type of fabrication process and the type of product. The data collection and analysis unit 120 can be implemented as software on a computer system.

Each “stage” or “module” of the fabrication process is subject to a “process recipe.” A process recipe is akin to a common kitchen recipe. That is, generally speaking, a process recipe details the types of material, the amounts of material, and the conditions to be applied in one or more of the stages of the fabrication process. For example, a process recipe can prescribe a target value for parameters (variables) such as pressure, temperature, gas flow rates, etc.

At different times, different process recipes may be applied to a stage. In other words, a first type of product may be processed in a particular stage according to first recipe, and a second type of product may be processed in that same stage according to a second (different) recipe.

For any of a variety of reasons, the actual or measured conditions in a stage may differ from the target values. The data collection and analysis unit 120 collects raw data (e.g., measured values) from the fabrication equipment 110, and analyzes (treats) that data to produce indicators (metrics) that reflect the health of the fabrication process. More specifically, by comparing measurement-based values and target values, the data collection and analysis unit 120 can identify if there is a problem somewhere in the fabrication process. (A “measurement-based value,” as used herein, refers generally to either a parameter value that is measured as the fabrication process is being performed, or to a treated or transformed value that is based on or derived from such a measured value.) Consequently, the data collection and analysis unit 120 can also predict whether or not the quality of the finished product is acceptable.

According to embodiments of the present invention, the data collection and analysis unit 120 utilizes a normalization module 130. Although the normalization module 130 is shown as a separate element in FIG. 1, the present invention is not so limited; the normalization module 130 may be an integral component of the data collection and analysis unit 120.

The normalization module 130 accesses historical values of process parameters, setpoints, or the like, and uses that information as described more fully below to normalize measurement-based values. The normalized values can each be compared to an acceptance criterion or condition to determine whether they are acceptable or within an acceptable range. That is, if the normalized values are acceptable, then it can be presumed that the fabrication process is healthy and that the finished products (e.g., wafers) are of high quality. On the other hand, if one or more of the normalized values are not acceptable, then there may be a problem with the fabrication process and corrective actions may be necessary.

By normalizing measurement-based values, a single “process control strategy” can be employed per process stage. A process control strategy may define, for example the context of the data (e.g., the process to be controlled), the data to be used (what data should be analyzed), and how the data is to be interpreted. A process control strategy may also define actions to take based upon the interpreted data (e.g., the rules to apply and the corrective actions to be taken when rules are violated).

For example, consider a first recipe (recipe 1) that prescribes, among other values, a target flow rate (flow rate 1) of 100 units and a second recipe (recipe 2) that prescribes a flow rate (flow rate 2) of 200 units. Recipe 1 is utilized in stage N when product 1 is being processed in that stage, and recipe 2 is utilized in stage N when product 2 is being processed in that stage. Without normalization, a first control strategy would be needed for stage N when recipe 1 was invoked, and a second control strategy would be needed for stage N when recipe 2 was invoked. With normalization, the measured flow rates 1 and 2 can be treated and then normalized using, for example, the target flow rates 1 and 2, respectively; different normalization methodologies are detailed below. The normalized values of the flow rates 1 and 2 are thus dimensionless. Also, if the actual flow rates are in accordance with their respective recipes, then the normalized values are roughly equal to each other. That is, if the actual flow rates are correct, then the normalized flow rates would each have a value of around 1.0. As such, a single process control strategy can be defined for both recipe 1 and recipe 2 (as well as other recipes applied in stage N). For example, a single acceptance criterion or range can be defined for all recipes applied in stage N.

FIG. 2 shows information flow in a process monitoring system such as the system 100 (FIG. 1) in accordance with one embodiment of the present invention. In the example of FIG. 2, the data collection and analysis unit 120 accesses historical values and/or setpoints as well as measurement-based values, and calculates normalized values. As mentioned above, the measurement-based value may be an actual measured value; if actual measured values are normalized, the normalized values can be treated. Alternatively, the measurement-based value may be the treated value.

In one embodiment, normalization is accomplished by calculating the ratio between the measurement-based value of a parameter and a normalization parameter associated with that particular parameter:

Normalized_value=(Measurement-based_value)/(Normalization_parameter). (1)

In equation (1), the normalization parameter can be the target value (e.g., a setpoint) specified by the process recipe for the parameter of interest:

Normalized_value=(Measurement-based_value)/(Parameter_setpoint). (2)

Recall the example presented above. According to that example, if recipe 1 is being utilized, then the normalization parameter would have a value of 100 units. While the normalization parameter may be recipe-dependent, the normalized value is independent of the recipe.

A parameter may not have an associated setpoint or specified target value. In that situation, historical data can be used to determine the normalization parameter. More specifically, the mean of a set of measurement-based values of the parameter of interest may be used as the normalization parameter:

Normalized_value=(Measurement-based_value)/(Parameter_mean). (3)

In equations (1), (2) and (3), ideally the normalized value has a value of 1.0. In practice, a range of acceptable values can be specified.

The set of samples used to determine the mean value can be selected in a variety of ways. That is, a user can define the period of time over which the samples are to be collected and can also define how many samples are to be included in the set. Generally, the set of samples would include only measurement-based values for the parameter of interest for those instances in which the product being manufactured was of satisfactory quality. Using the mean value, any type of variable (e.g., tunable, non-tunable, or shifting) can be controlled.

In another embodiment, normalization is accomplished by taking into account the variability of the parameter of interest within the normalization computation:

Normalized_value=(Measurement-based_value−Parameter_mean)/(Parameter_σ); (4)

where “Parameter_σ” is the standard deviation of a set of measurement-based (e.g., actual) values of the parameter of interest (the same set used to determine Parameter_mean), and where the set of samples used to determine the mean value can be selected in a variety of ways as mentioned above. Furthermore, in the present embodiment, the sample set can change over time—for example, samples can be collected during a moving window of time, such that newer samples are added to the set while older samples are removed from the set.

In equation (4), the normalized value is auto-controlled (self-limiting). That is, for quality products, the normalized value will have a value of about 1.0 and the measurement-based value will be within one sigma of the mean. Accordingly, a generic limit of one sigma can be set for process control strategies. Thus, process control strategies can be established once and for all, if so desired. Note that generic limits different from a value of one sigma can be established. For example, a two-sigma value or three-sigma value can be used in equation (4).

There may be occasions in which it is necessary to “prime” the historical data. For example, after preventive maintenance or after parts are changed, aspects of the manufacturing process may change so much that the historical data is no longer relevant, making it necessary to collect new information in order to build up a new set of historical information. During priming, until sufficient historical information is collected, normalization may be suspended or it may be based on a reduced sample size. Also, products (e.g., wafers) that are acceptable are identified (e.g., by inspection) so that only metrics associated with good products are included in the historical information. Once priming is complete—once there is enough historical information accumulated—the products no longer have to be inspected for quality (although they can be). A user can specify how long the period of priming should last. That is, a user can specify how many samples are needed to complete the set of historical information.

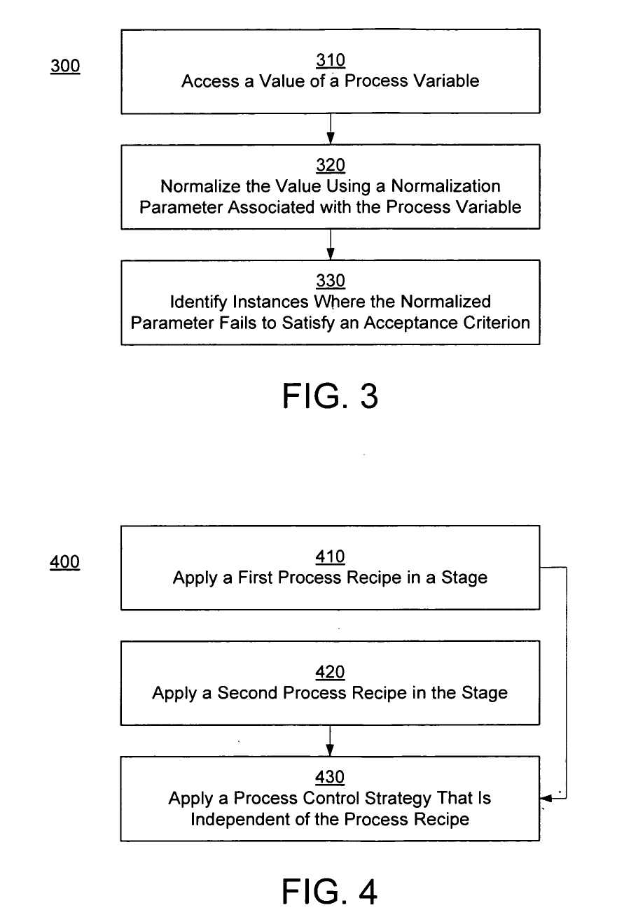

FIG. 3 is a flowchart 300 of an example of a computer-implemented method for monitoring a manufacturing process according to one embodiment of the present invention. In one embodiment, the method of the flowchart 300 is implemented by the data collection and analysis unit 120 in combination with the fabrication equipment 110 of FIG. 1.

In block 310 of FIG. 3, a measurement-based value of a process variable is accessed. In one embodiment, the measurement-based value is the actual measured (pre-treated) value of the process variable. In another embodiment, the measurement-based value is the treated value—that is, the value of the process variable is measured, the measured value is treated, and the treated value is accessed. If actual measured values are normalized, the normalized values can be treated.

In block 320, the measurement-based value is normalized using a normalization parameter associated with the process variable to produce a normalized value.

In block 330, instances where the normalized value fails to satisfy an acceptance criterion or condition are identified.

FIG. 4 is a flowchart 400 of a method for controlling a manufacturing process according to one embodiment of the present invention. In one embodiment, the method of flowchart 400 is implemented in the system 100 of FIG. 1.

In block 410 of FIG. 4, a first process recipe is applied during processing of a first product in a stage of a manufacturing process.

In block 420, a second process recipe is subsequently applied during processing of a second product in the stage.

In block 430, a process control strategy is applied in the stage, where the process control strategy is independent of the process recipe being applied in the stage, and where the process control strategy is the same for both the first and second process recipes.

Although specific steps are disclosed in the flowcharts 300 and 400, such steps are exemplary. That is, embodiments of the present invention are well-suited to performing various other steps or variations of the steps recited in the flowcharts. The steps in the flowcharts may be performed in an order different than presented. Furthermore, the methods of the flowcharts 300 and 400 can be employed in real time (on line) as the manufacturing process is being performed, although the methods are also suitable for post-processing.

In summary, by normalizing the measurement-based values of process variables as described herein, control strategies are not dependent on the process recipe being employed within a stage (e.g., process chamber). Hence, changes can be made to process recipes without necessarily changing control strategies. Furthermore, the number of control strategies can be reduced, and consequently less time is needed to maintain and update them. Ideally, only a single control strategy is required for each stage.

Also, the resulting control strategies are essentially insensitive to preventive maintenance, more robust, and can be readily deployed across chambers and tools in the same family. Normalization also makes process control strategies essentially insensitive to the “first wafer effect.” In addition, normalization can successfully compensate for strategy instabilities and expand the use of Multivariate Fault Detection.

Gaussian process classifier quality value (GPCQV) is an indicator of a signal's historical population gaussianity. Representative empirical data demonstrates that, for a given process and for all involved indicators, GPCQV is acceptable with normalization but is not acceptable without normalization. Empirical data also demonstrates that the anomaly (or fault) “signatures” (e.g., a chart showing divergence from normality for every signal's indicator) are more stable after normalization—for example, a Hotelling T² chart has lower values and fewer false alarms. Thus, with normalization, faults continue to be successfully detected but, advantageously, the number of false alarms is reduced.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of monitoring a manufacturing process, said method comprising:
accessing a measurement-based value of a process variable;
normalizing said measurement-based value using a normalization parameter associated with said process variable to produce a normalized value; and
identifying instances where said normalized value fails to satisfy an acceptance criterion.

2. The method of claim 1 wherein said normalization parameter is a target value specified for said process variable.

3. The method of claim 1 wherein said normalization parameter is the mean of a number of samples of measurement-based values of said process variable.

4. The method of claim 3 wherein said samples are measured over a window of time that begins at a selectable starting point.

5. The method of claim 1 wherein said normalizing comprises calculating a ratio of said measurement-based value to said normalization parameter, wherein said ratio is said normalized value.

6. The method of claim 1 wherein said normalizing comprises:
calculating a difference between said measurement-based value and the mean of a number of samples of measurement-based values of said process variable; and
dividing said difference by the standard deviation of said number of samples to produce said normalized value.

7. The method of claim 1 wherein said accessing, normalizing and identifying are performed in real time as said manufacturing process is being performed.

8. The method of claim 1 wherein said manufacturing process comprises a semiconductor fabrication process.

9. A computer-readable medium having computer-executable instructions for performing a method of monitoring a fabrication process, said method comprising:
accessing a first indicator value for a parameter associated with a stage of said fabrication process, wherein said first indicator value is based on measurements made during processing of a first product in said stage and wherein said parameter has a first target value for said first product;
accessing a second indicator value for said parameter, wherein said second indicator value is based on measurements made during processing of a second product in said stage and wherein said parameter has a second target value for said second product, wherein said second target value is different from said first target value;
normalizing said first indicator value using a first normalization parameter to produce a first normalized value;
normalizing said second indicator value using a second normalization parameter to produce a second normalized value;
comparing each of said first and second normalized values to a condition; and
identifying instances in which at least one of said first and second normalized values fails to satisfy said condition.

10. The computer-readable medium of claim 9 wherein said first normalization parameter and said second normalization parameter are said first and second target values, respectively.

11. The computer-readable medium of claim 9 wherein said first normalization parameter is the mean of a first set of indicator values for said parameter when said parameter is supposed to have said first target value, and wherein said second normalization parameter is the mean of a second set of indicator values of said parameter when said parameter is supposed to have said second target value.

12. The computer-readable medium of claim 9 wherein said normalizing said first indicator value comprises calculating a ratio of said first indicator value to said first normalization parameter, wherein said ratio is said first normalized value.

13. The computer-readable medium of claim 9 wherein said normalizing said first indicator value comprises:
calculating a difference between said first indicator value and the mean of a number of samples of indicator values of said parameter when said parameter is supposed to have said first value; and
dividing said difference by the standard deviation of said number of samples to produce said first normalized value.

14. The computer-readable medium of claim 9 wherein said fabrication process comprises a semiconductor fabrication process and wherein said first and second products are wafers.

15. A method of process control in manufacturing, said method comprising:
applying a first process recipe during processing of a first product in a stage of a manufacturing process at a first time;
applying a second process recipe during processing of a second product in said stage at a second time; and
applying a process control strategy in said stage, wherein said process control strategy is independent of a process recipe being applied in said stage and wherein said process control strategy is the same for both said first and second process recipes.

16. The method of claim 15 further comprising:
normalizing a first measurement-based value of a parameter to produce a first normalized value, wherein during processing of said first product said parameter has a first target value that is specified according to said first process recipe;
normalizing a second measurement-based value of said parameter to produce a second normalized value, wherein during processing of said second product said parameter has a second target value that is specified according to said second process recipe; and
comparing each of said first and second normalized values to an acceptance criterion.

17. The method of claim 16 further comprising using said first and second target values to normalize said first and second measurement-based values, respectively.

18. The method of claim 16 further comprising:
determining a first mean of a first set of measurement-based values of said parameter measured when said parameter is supposed to have said first target value;
determining a second mean of a second set of measurement-based values of said parameter measured when said parameter is supposed to have said second target value; and
using said first and second means to normalize said first and second measurement-based values, respectively.

19. The method of claim 16 wherein said normalizing said first measurement-based value comprises calculating a ratio of said first measurement-based value to said first normalization parameter, wherein said ratio is said first normalized value.

20. The method of claim 16 wherein said normalizing said first measurement-based value comprises:
calculating a difference between said first measurement-based value and the mean of a number of samples of measurement-based values of said parameter measured when said parameter is supposed to have said first target value; and
dividing said difference by the standard deviation of said number of samples to produce said first normalized value.
